(19) United States
(12) Patent Application Publication
(10) Pub. No.: US 2007/0297701 A1
(43) Pub. Date: Dec. 27, 2007

(54) Pill crusher pouch for use with a pill crusher

(75) Inventors: Mark Engel, Encino, CA (US); Song Yang, Shanghai (CN)

Correspondence Address: PAUL A. FATTIBENE;FATTIBENE & FATTIBENE, 2480 POST ROAD, SOUTHPORT, CT, 06890, US

(73) Assignee: Tiger Medical Products (US), Inc.

(21) Appl. No.: 11/818,784

(22) Filed: Jun. 15, 2007

Related U.S. Application Data
(63) Continuation-in-part of application No. 29/252,170, filed on Jan. 19, 2006, now Pat. No. D551989.

(51) Int. Cl. B65D 30/16; A47J 17/00

(52) U.S. Cl. 383/104; 241/168

(57) ABSTRACT

A pill crusher pouch having ribs and intersecting straight bottom seal portions. The pill crusher pouch is used for holding a pill or tablet to be crushed by a pill crusher device so as to form a powder that can easily be dispensed and provided to a patient. The ribs increase the strength of the walls of the pouch, preventing rupture. In one embodiment, the ribs have a fiber material therein, increasing the strength. A bottom seal of the pouch is formed by straight portions intersecting at obtuse angles increase the strength of the bottom seal and permitting more complete dispensing of the powdered pill. The substantially straight portions increase strength and the obtuse angles prevent a portion of the powdered pill from being trapped within the pill pouch, thereby providing for substantially complete dispensing of the powdered pill. The strength of the pill pouch is improved preventing unintentional rupturing, that could result in possible contamination or improper dosing of the medicament contained within the pill.

### RELATED APPLICATION

This application is a continuation-in-part of application Ser. No. 29/252,170 filed Jan. 19, 2006.

### FIELD OF THE INVENTION

The present invention relates to a pouch used to contain a pill to be crushed for dispensing to a patient or mixing with other medicaments, and in particular to a stronger pouch that is less prone to breaking and is capable of dispensing the pulverized or powdered pill efficiently.

### BACKGROUND OF THE INVENTION

Small plastic pouches have been used to contain a pill to be crushed. It is often desirable that in dispensing a medicament in the form of a pill that it be crushed or pulverized to a powder form for even mixing or dispensing to a patient. Often, this has been done by placing the pill into a small pouch and placing the pouch in a pill crusher having an anvil and movable platen. A mechanical advantage is used so as to apply a force to the pouch and pill contained therein, crushing the pill between the anvil and movable platen. One such pill crushing device is disclosed in U.S. Pat. No. 5,915,637 entitled “Pill Crusher” and issuing to Parsons on Jun. 29, 1999. Therein disclosed is a pill crusher having an anvil fixed to a base and a movable handle compression link pivotally coupled to the base and a platen providing a mechanical advantage for crushing a pill placed between the anvil and movable platen. Also disclosed therein is a pill pouch having a straight line bottom seal. Another pouch is disclosed in U.S. Pat. No. 7,051,963 entitled “Pill Crusher Pouch and Method of Using Same” issuing to Buckley on May 30, 2006, which is herein incorporated by reference. Therein disclosed is a pill crusher pouch having a cup like seal line that provides a rounded or circular like cornerless bottom that does not have any sharp pointed corners, which is herein incorporated by reference.

While the prior pouches have been suitable for crushing pills within a pill crusher, upon occasion the pill pouches may rupture or break due to the extreme forces used in crushing the pill to a powder form. The walls of the pouch or seal may rupture, causing contamination of the pill crusher and loss of potentially expensive medicine. Should the pill pouch rupture, cross-contamination may result, as well as uncertainty as to the content of the pill powder and dose. Therefore, it is important that a pill pouch be used that is less prone to breakage. Additionally, while a cup like or curved seal does help to prevent powder from accumulating in the corners of a straight line sealed pouch, it may be more prone to rupture since there is less space for the pills to travel in the pouch during the crushing actions.

Therefore, there is a need to obtain a stronger pouch that has improved strength, easier dispensing, and that is also inexpensive to manufacture.

### SUMMARY OF THE INVENTION

The present invention is directed to a pouch used for holding a pill to be crushed in a pill crusher device that is resistant to rupturing or breakage. The pill pouch of the present invention has different ribbing structures that increase the strength of the walls of the pill pouch so as to prevent breakage and a bottom seal that is less prone to rupturing and has a shape to more completely dispense the powder of the pulverized pill.

Ribs of increased material thickness are used on the walls of the pouch to increase strength of the pouch and prevent rupturing.

In one embodiment, a composite rib is utilized using a strong fiber material contained therein. In another embodiment, a fiber material is encapsulated and sealed within the wall of the pouch.

In another embodiment, a bottom seal has a substantially straight portion and angled end portions forming an obtuse corner so as to improve seal strength and permit more complete dispensing of the powder of the pulverized pill.

In another embodiment, the seal is formed from two straight portions forming an angled center portion and having angled end portions.

In another embodiment, the seal is formed by two straight portions intersecting at an obtuse angle.

The bottom seals of the present invention provide a plurality of straight sections connected by obtuse angles, improving strength and permitting easy dispensing of the powder from a pulverized pill.

Accordingly, it is an object of the present invention to reduce the possibility of breakage of a pill pouch during the crushing of a pill contained therein.

It is another object of the present invention to provide an efficient pill pouch that permits substantially complete dispensing of the powder formed from the pulverized pill.

It is an object of the present invention to provide a stronger wall structure and seal configuration for a pill pouch.

It is another advantage of the present invention that it provides more reliable dosing of medicament.

It is a feature of the present invention that ribs are formed in the walls of the pouch, adding to the strength of the pouch and preventing unintentional rupture.

It is another feature of the present invention that straight seal portions are connected by obtuse angles.

These and other objects, advantages, and features will become more readily apparent in view of the following more detailed description.

### BRIEF DESCRIPTION OF THE DRAWINGS

FIG. 1 is a perspective view of one embodiment of the present invention.

FIG. 2A schematically illustrates a partial view of a wall section of the embodiment illustrated in FIG. 1.

FIG. 2B is a schematic view illustrating a partial view of a wall section illustrating another embodiment of a rib structure.

FIG. 2C is a schematic partial view of a wall section illustrating another embodiment of a rib structure.

FIG. 3 is an elevational view schematically illustrating a seal configuration of another embodiment of the present invention.

FIG. 4 is an elevational view schematically illustrating another seal configuration in another embodiment of the present invention.

FIG. 5 is an elevational view schematically illustrating another embodiment of the present invention having horizontal ribs.

FIG. 6 is an elevational view schematically illustrating another embodiment of the present invention having cross hatched ribs.

FIG. 7 is an elevational view schematically illustrating another embodiment of the present invention having diagonal ribs.

### DETAILED DESCRIPTION OF THE PREFERRED EMBODIMENTS

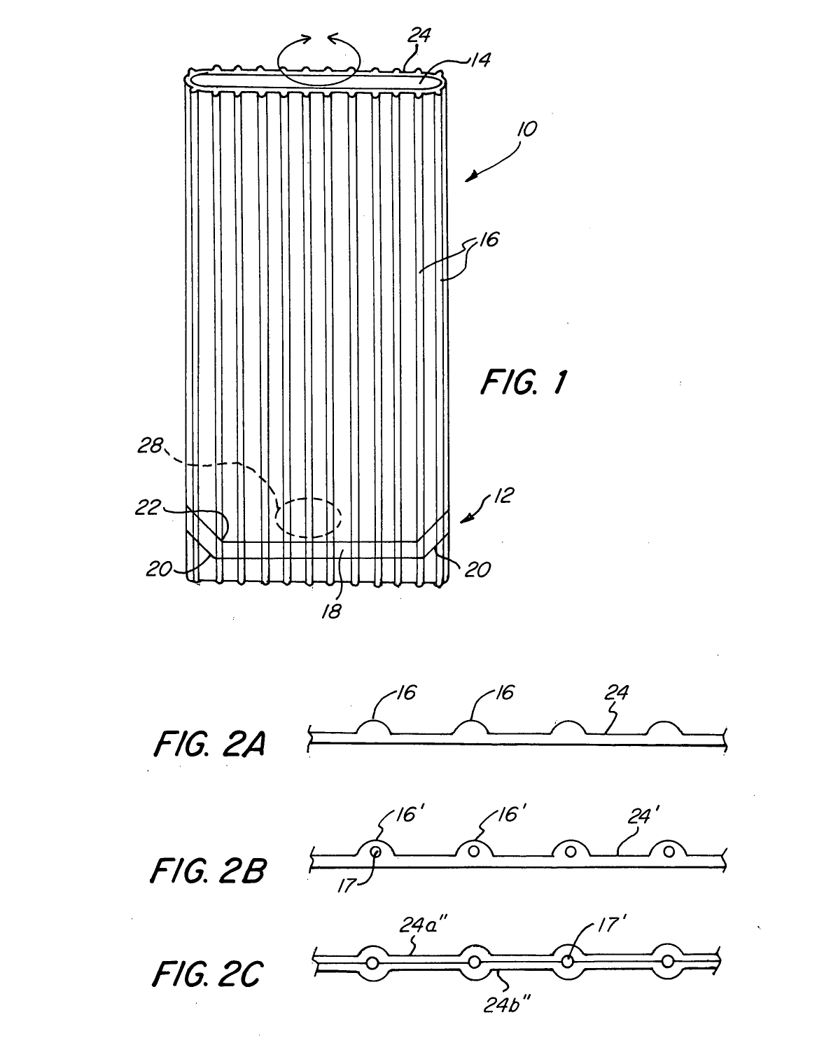

FIG. 1 is a perspective view illustrating one embodiment of a pill pouch 10 of the present invention. The pill pouch 10 has a seal 12 at a sealed end and opening 14 at an open end. Placed on walls 24 are longitudinal ribs 16. The longitudinal ribs 16 extend the entire length of the walls 24 of pouch 10. Seal 12 may be formed by any conventional sealing method such as heat sealing, ultrasonic welding, or other known sealing techniques. The pill pouch 10 is preferably made of a thin plastic tube of material such as polyethylene. The pill pouch 10 is preferably made of a translucent material, but may be opaque. The seal 12 has a substantially straight portion 18. The substantially straight portion 18 extends for a substantial portion of the bottom lateral distance. Angled bent portions 20 are formed at either end of the straight portions 18 and form an obtuse angle 22 at the vertex or intersection of the straight portion 18 and the angled end portions 20. The obtuse angle 22 is preferably greater than one hundred and thirty-five degrees.

The substantial straight portion 18 results in an easily fabricated strong seal portion that is less prone to rupture than curved or non-straight portions that sometimes may not seal completely or may have small areas where forces may be concentrated, creating a rupture. Therefore, forces generating in the process of pulverizing a pill may be spread out along the length of the substantial straight portion 18. The substantially straight portion 18 uniformly distributes the forces so as to prevent rupture of the seal. The angled end portions 20 form an obtuse angle 22 with the straight portion 18. This structure helps to prevent powder from the pulverized pill from accumulating and facilitate complete dispensing from the pouch 10.

FIG. 2A schematically illustrates a portion of the wall 24 of the pouch 10 illustrated in FIG. 1. For reasons of economy, the wall 24 is relatively thin and therefore sometimes prone to rupture or piercing due to sharp fragments of a broken pill. The pill 28 may preferably have a size that extends across several ribs 16. That is the lateral distance between ribs 16 is less than the diameter of a pill 28. Therefore, the ribs 16 greatly facilitate the structural strength of the pouch across the surface of the pill 28. The ribs 16 are raised portions of increased thickness of material that can improve strength without the need for increasing the thickness of the entire wall 24.

FIG. 2B schematically illustrates another embodiment of a pouch having a composite rib structure. Pouch wall 24′ has formed thereon ribs 16′ having imbedded therein a fiber material 17. The fiber material 17 generally may be made of a material much stronger than the material of the wall 24′ and surrounding rib structure 16′. This composite structure greatly improves the strength of the walls 24′ of the pouch.

FIG. 2C schematically illustrates a wall portion of another embodiment of the present invention. In this embodiment, the wall is formed by a first sheet 24″a and a second sheet 24″b having a fiber material 17′ placed there between. The two sheets 24″a and 24″b are sealed together, encapsulating the fiber material 17′. Accordingly, the fiber material 17′ is imbedded in the wall of the pill pouch providing substantially enhanced structural strength preventing rupture of the wall.

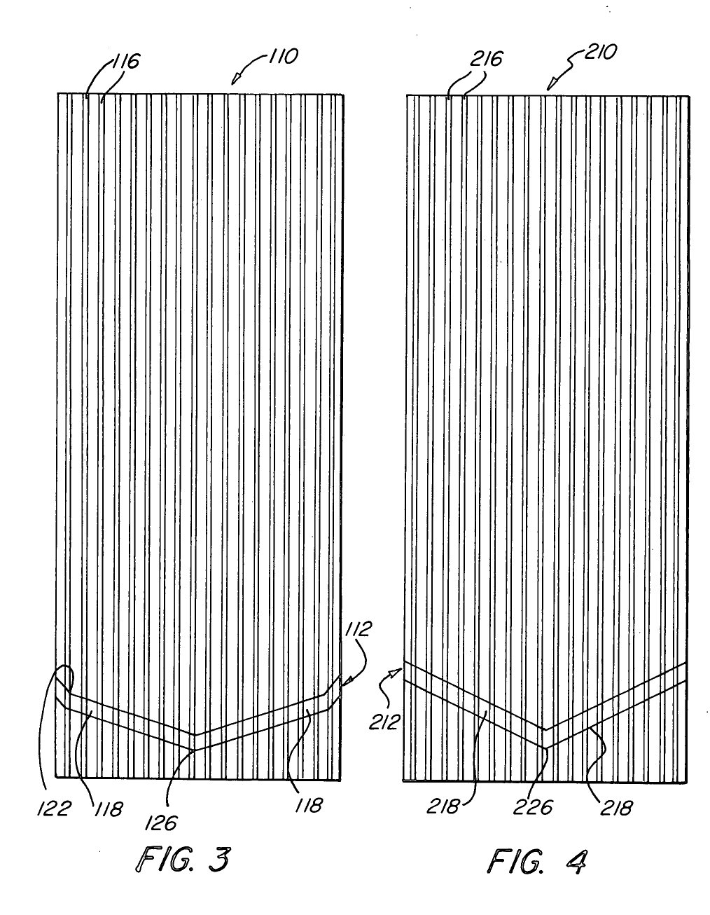

FIG. 3 is another embodiment of a pill pouch 110 having longitudinal ribs 116 and a bottom seal 112. The ribs 116 can be comprised of any of the configurations as illustrated in FIGS. 2A-C. The bottom seal 112 is formed from two substantially straight portions 118, intersecting at a center angled portion 126. Slightly curved end portions 120 form an obtuse angle 122 with the substantially straight portions 118. The angled center portion 126 preferably forms a relatively large angle, generally greater than 160° but less than 180°.

FIG. 4 schematically illustrates another embodiment of the present invention. In this embodiment, the pouch 210 has longitudinal ribs 216 and a bottom seal 212. The bottom seal 212 is formed by two substantially straight portions 218, intersecting at an obtuse angle 226.

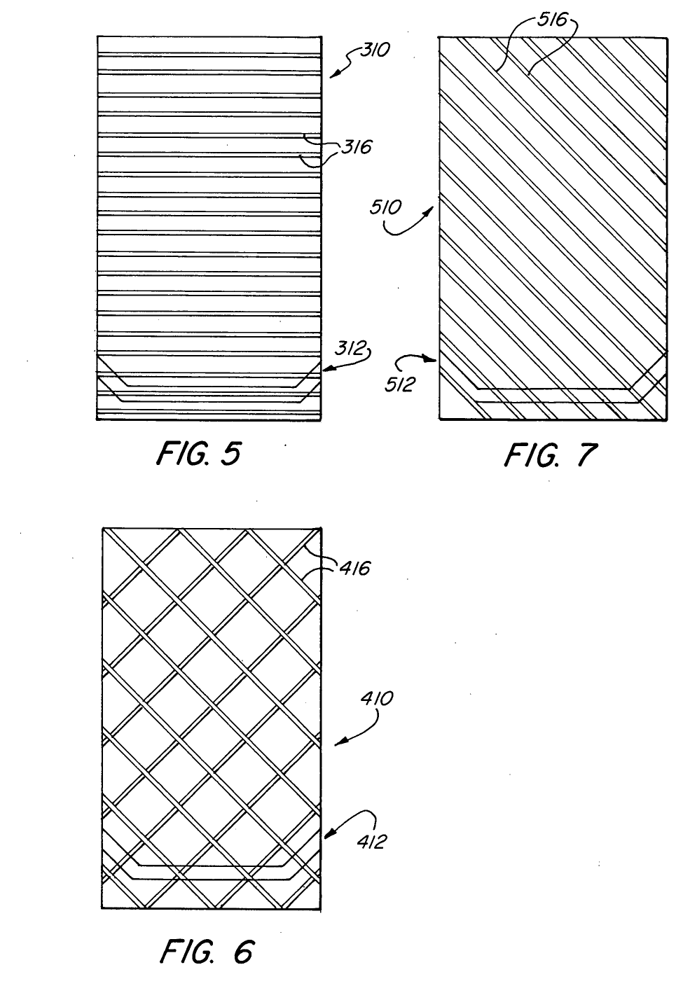

FIG. 5 illustrates another embodiment of the present invention. In this embodiment, a pill pouch 310 has horizontal or lateral ribs 316 and a bottom seal 312.

FIG. 6 illustrates another embodiment of the present invention. In this embodiment, a pill pouch 410 has cross hatched ribs 416 and a bottom seal 412.

FIG. 7 is yet another embodiment of the present invention. In this embodiment a pill pouch 510 has diagonal ribs 516 and a bottom seal 512.

It should be appreciated from FIGS. 5-7 that various differing configurations of ribs may be used while still achieving the increased strength of the walls.

Additionally, differing configurations of seals having substantially straight portions connected by obtuse angles may be utilized to provide a strong seal that is less prone to rupture and a configuration that facilitates substantially complete dispensing of the powder formed from the pulverized pill.

The different embodiments of the present invention provide a relatively simple, cost effective, and strong pill pouch that can be used in a pill crusher device. The present invention improves the safety and reliability of pill pouches. The present invention therefore improves upon the previously known pill pouches and advances the art.

While several embodiments have been illustrated and described with respect to the present invention, it should be appreciated that various modifications may be made without departing from the spirit and scope of this invention.

What is claimed is:

1. A pill crusher pouch comprising:
a tube forming walls;
ribs formed on the walls; and
a bottom seal formed on one end of said tube comprising a plurality of straight portions intersecting at an obtuse angle,
whereby a pill placed in the pill crusher pouch is capable of being crushed forming a powder with a very high likelihood of not rupturing the walls or said bottom seal and facilitating easy dispensing of the powder.

2. A pill crusher pouch as in claim 1 wherein:
said ribs extend longitudinally.

3. A pill crusher pouch as in claim 1 wherein:
said ribs extend laterally.

4. A pill crusher pouch as in claim 1 wherein:
said ribs extend diagonally.

5. A pill crusher pouch as in claim 1 further comprising:
fibers contained within said ribs, whereby said ribs are reinforced.

6. A pill crusher pouch as in claim 1 wherein:
said bottom seal comprises a straight portion over a substantial length of the lateral width of said tube.

7. A pill crusher pouch as in claim 1 wherein:
said bottom seal is V-shaped.

8. A pill crusher pouch as in claim 6 further comprising:
angled end portions formed on each end of the straight portion of said bottom seal, said angled end potions forming an obtuse angle with the straight portion.

9. A pill crusher pouch as in claim 8 wherein:
the obtuse angle of said angled end portions is greater than one hundred and thirty-five degrees.

10. A pill crusher pouch used for crushing a pill in a pill crusher comprising:
a tube forming walls having a lateral width;
ribs formed on the walls; and
a bottom seal having a central straight portion extending a substantial portion of the lateral width of said tube and an angled end portion placed adjacent each end of the central straight portion, each angled end portion intersecting the central straight portion at an obtuse angle,
whereby a pill placed in the pill crusher pouch is capable of being crushed forming a powder with a very high likelihood of not rupturing the walls or said bottom seal facilitating easy dispensing of the powder.

11. A pill crusher pouch used for crushing a pill in a pill crusher as in claim 10 wherein:
the obtuse angle is greater than one hundred and thirty-five degrees.

12. A pill crusher pouch used for crushing a pill in a pill crusher as in claim 10 wherein:
said ribs extend longitudinally.

13. A pill crusher pouch used for crushing a pill in a pill crusher as in claim 10 wherein:
said ribs extend laterally.

14. A pill crusher pouch used for crushing a pill in a pill crusher as in claim 10 wherein:
said ribs extend diagonally.

15. A pill crusher pouch used for crushing a pill in a pill crusher comprising:
a flexible tube made of flexible plastic forming walls, said flexible tube having a lateral width;
a plurality of longitudinal raised ribs formed on the walls of said flexible tube; and
a bottom seal having a central straight portion extending a majority of the lateral width of said flexible tube and an angled end portion placed adjacent each end of the central straight portion, each angled end portion intersecting the central straight portion at an obtuse angle greater than one-hundred and thirty-five degrees,
whereby a pill placed in the pill crusher pouch is capable of being crushed forming a powder with a very high likelihood of not rupturing the walls or said bottom seal and facilitating easy dispensing of the powder.

16. A pill crusher pouch comprising:
a tube forming walls;
ribs formed on the walls; and
a bottom seal formed on one end of said tube,
whereby a pill placed in the pill crusher pouch is capable of being crushed forming a powder with a very high likelihood of not rupturing the walls.
